(19) United States
(12) Patent Application Publication
(10) Pub. No.: US 2026/0179483 A1
(43) Pub. Date: Jun. 25, 2026

(54) DRIVER ASSISTANCE SYSTEM FOR A MOTOR VEHICLE, MOTOR VEHICLE AND METHOD

(71) Applicant: AUDI AG, Ingolstadt (DE)

(72) Inventor: Sebastien AMBROSETTI, Waidhofen (DE)

(73) Assignee: AUDI AG, Ingolstadt (DE)

(21) Appl. No.: 19/421,484

(22) Filed: Dec. 16, 2025

(30) Foreign Application Priority Data
Dec. 20, 2024 (DE) 10 2024 139 474.9

(51) Int. Cl. G08G 1/01; G01C 21/36; G08G 1/0967

(52) U.S. Cl. CPC G08G 1/0137; G01C 21/3626; G08G 1/096766

(57) ABSTRACT

A driver assistance system for a motor vehicle comprising a position recording device to record a position of the motor vehicle, a receiving device to receive data characterizing at least one further vehicle, the data describing at least one position of the at least one further vehicle, an electronic computing device which is designed to determine the at least one position of the at least one further vehicle based on the data received by the receiving device and, based on the recorded position of the motor vehicle and the received data, to produce a virtual map, characterizing a surrounding of the motor vehicle, with the recorded position of the motor vehicle and with the determined at least one position of the at least one further vehicle.

### CROSS REFERENCE TO RELATED APPLICATIONS

This application is a based upon and claims the priority benefit of German Application No. 10 2024 139 474.9 filed on Dec. 20, 2024, the entire contents of which are incorporated by reference herein.

### BACKGROUND

### 1. Field

The invention relates to a driver assistance system for a motor vehicle. Furthermore, the invention relates to a motor vehicle with a driver assistance system and to a method for operating a motor vehicle.

Car2x is a capability known in the prior art, in which vehicles communicate with their environment (“x”), but also with each other. If the vehicles communicate with each other, this can be referred to as Car2Car communication. Data exchange between two vehicles, for example neighboring ones, is therefore a special case of Car2X and is accordingly called Car2Car. By means of Car2Car communication, motor vehicles can obtain information, for example about other vehicles, which are in particular situated in the vicinity of the motor vehicle. This allows the motor vehicles to obtain information, for example about traffic, possible congestion and/or accidents. Usually, however, only few events are communicated via Car2x, with the result that, for example, only one event, for example in the form of a broken-down vehicle, and its position, are passed on, for example in the form of GPS data.

### 2. Description of the Related Art

DE 10 2022 003 165 A1 discloses a vehicle assistance system for at least partially autonomous control of a vehicle with a vehicle computing unit which is set up to produce, using sensor data recorded via dedicated sensors of the vehicle and/or sent to the vehicle, a model of the vehicle in spatial relation to objects recognized in the sensor data, wherein the vehicle is part of a vehicle fleet in a vehicle network which further comprises a vehicle-external server which is in communication with fleet vehicles of the vehicle fleet.

In addition, a system for identifying sudden danger points in road traffic is to be taken from DE 10 2020 105 739 A1 as known, comprising a back end and a plurality of vehicles, wherein at least one vehicle comprises a sensor unit which is set up to record driving behavior data of the driver of the vehicle and technical data of the vehicle and to record technical data of the vehicle.

Furthermore, DE 10 2017 203 838 A1 discloses a method for recording a surrounding area, in which a first motor vehicle records its vehicle surrounding area by means of at least one sensor, wherein the first motor vehicle transfers sensor data, relating to its vehicle surrounding area, of the sensor to a vehicle-external server device, at least one second motor vehicle with at least one sensor transfers sensor data, relating to its vehicle surrounding area, of the sensor to the vehicle-external server device and the vehicle-external server device merges the transferred sensor data of the motor vehicles and, based thereon, generates a surrounding area model of the vehicle surrounding area of the first motor vehicle.

### SUMMARY

The present invention is based on the object of providing a driver assistance system for a motor vehicle, a motor vehicle and a method for operating a motor vehicle, so that a driver of the motor vehicle can be particularly well supported in their driving task.

The object is achieved by the subject matter of the independent claims. Advantageous further developments of the invention are described by the dependent claims, the description that follows, and the figures.

One aspect of the invention relates to a driver assistance system for a motor vehicle or of the motor vehicle. The motor vehicle is preferably configured as a motorized vehicle, in particular as a passenger car or as a truck, or as a passenger bus or a motorcycle.

The driver assistance system has at least one position recording device for recording a current position of the motor vehicle. This means that by the position recording device, the current position of the motor vehicle can be recorded or is recorded, can be determined or is determined. In other words, the position recording device is designed to record the position of the motor vehicle. The position of the motor vehicle is understood in particular to be a position of the motor vehicle in the surroundings of the motor vehicle. Therefore, the position can be understood in particular to be a location of the motor vehicle, that is to say a location of the motor vehicle in the surroundings. Recording the position can be understood in particular to be detecting the position. The recording of the position of the motor vehicle by the position recording device is done by GPS, for example.

Furthermore, the driver assistance system has at least one receiving device for receiving data characterizing at least one further vehicle. This means that, by the receiving device, the data characterizing the further vehicle can be received or are received. The further vehicle is a vehicle that is different than the motor vehicle. For example, the further vehicle is another a motor vehicle, that is different from the at least one further vehicle. That the data characterize the further vehicle can be understood to mean in particular that the data describe the vehicle, that is to say at least one property of the further vehicle. The data describe, in particular include, at least one position of the further vehicle. In other words, the data characterize at least the position of the further vehicle. The data can therefore be referred to as position data or can at least include the position data.

The position of the further vehicle is understood in particular to be a position of the further vehicle in the surroundings. Therefore, the position of the further vehicle can be understood in particular to be a location, that is to say in particular a location of the further vehicle in the surroundings. For example, the position of the further vehicle may be a current position or a past position of the further vehicle. By the current position, it is understood in particular to mean that the vehicle, when the data are received by the receiving device, that is to say during a receiving time at which the data are received by the receiving device of the motor vehicle, has the position at least approximately, that is to say still has the position. By the past position, it is understood in particular to mean that when the data are received by the receiving device, that is to say, during the receiving time, a time period has already passed since the position described by the data has been determined. This means that the position of the further vehicle may be out of date. The time period is, for example, at least one second, in particular several seconds, or at least one minute, in particular several minutes.

The data are, for example, data transmitted from at least one electronic computing device that is external with respect to the motor vehicle. Thus, the data are transmitted by the external electronic computing device, for example, in particular to the motor vehicle or the receiving device thereof. The electronic computing device is, for example, part of the further vehicle, with the result that the data can be transmitted from the further vehicle in particular to the motor vehicle or the receiving device thereof. Alternatively, the electronic computing device is formed, for example, as a vehicle-external electronic computing device, for example as a server. Receiving and/or transmitting the data can in particular be understood to be Car2x communication, for example Car2Car communication.

Furthermore, the driver assistance system has at least one electronic computing device, which can be understood in particular to be a data processing system. The electronic computing device is therefore formed in particular as a vehicle-internal electronic computing device with respect to the motor vehicle. Thus, the electronic computing device is formed in particular separately from the external electronic computing device. The electronic computing device is designed to determine, in particular to calculate, the current position of the further vehicle on the basis of the data received by the receiving device. This means that, by the electronic computing device on the basis of the data received by the receiving device, in particular, the current, position of the further vehicle can be determined or is determined, in particular can be calculated or is calculated.

In other words, the data received by the electronic computing device are used as an input variable to determine the current position of the further vehicle by the electronic computing device. Determining the position can be understood, in particular, to be anticipating, that is to say predicting, the position. If the data describe the current position of the further vehicle, a setting or stipulation of the position described by the data as the position of the vehicle takes place when the position of the further vehicle is determined by the electronic computing device, for example. If the data describe the past position of the further vehicle, when the current position is determined by the electronic computing device, a determination of the current position of the vehicle takes place, for example, on the basis of the past position, that is to say for example an adjustment or updating of the past position, in particular to obtain, that is to say to calculate the current position for example.

Furthermore, on the basis of the recorded position of the motor vehicle and on the basis of the received data, and in particular on the basis of the determined position of the further vehicle, the electronic computing device is designed to produce a virtual map, in particular a road map, characterizing the surroundings of the motor vehicle, with the recorded position of the motor vehicle and with the determined position of the further vehicle. This means that the virtual map characterizing the surroundings of the motor vehicle, with the recorded position of the motor vehicle and with the determined position of the further vehicle, can be produced or is produced by the electronic computing device on the basis of the recorded position of the motor vehicle and on the basis of the received data, in particular on the basis of the determined position. In other words, at least one model is produced, that is to say generated, by the electronic computing device, which model describes, that is to say in particular depicts, at least the surroundings of the motor vehicle, the position of the motor vehicle in the surroundings and the position of the further vehicle. The model or the map can thus be understood in particular to be a representation of the area surrounding the motor vehicle. In particular, the map depicts at least the surroundings, the position of the motor vehicle in the surroundings and the position of the further vehicle in the surroundings. Producing the virtual map can be understood in particular to be generating the virtual map.

In order to be able to support a driver of the motor vehicle particularly well in their driving task, that is to say in controlling the motor vehicle, the electronic computing device is designed, according to an aspect of the invention, to transmit, in a manual driving mode of the motor vehicle, at least one control signal for displaying the virtual map for the driver of the motor vehicle to at least one visual display device of the motor vehicle. This means that the control signal for displaying the virtual map can be transmitted or is transmitted, in particular can be sent or is sent, to the visual display device of the motor vehicle by the electronic computing device, with the result that the virtual map is displayed for the driver or the driver in particular by the visual display device. In other words, the electronic computing device causes the display device to display the virtual map to the driver. The control signal can therefore be understood in particular to be a display control signal. For example, the control signal describes the displaying of the virtual map. The displaying of the virtual map can be understood in particular to be a visual representation of the virtual map, wherein this visual representation can be seen by the driver of the motor vehicle in particular. The visual display device can be understood in particular to be a visual output device. The visual display device is formed, for example, as an in particular vehicle-integrated screen, which can also be referred to as a display.

By the feature “in manual driving mode”, it is understood in particular that the electronic computing device is designed to transmit the control signal for displaying the virtual map for the driver of the motor vehicle to the visual display device of the motor vehicle, in particular exclusively when the motor vehicle is in manual driving mode, that is to say in a manual driving operation mode. Manual driving mode can be understood in particular to be a state in which the driver drives the motor vehicle manually, that is to say themself. This means that there is no autonomous or automatic driving in manual driving mode. However, it may be possible that the motor vehicle is driven in a partially automated manner in manual driving mode, for example in accordance with level 2 degree of automation. Level 2 degree of automation can be understood in particular to be level 2 in accordance with SAE J3016.

For example, it is provided that the manual driving mode can be determined or is determined by the electronic computing device. This means that the electronic computing device can be used to check whether the vehicle is in manual driving mode. If the manual driving mode is determined by the electronic computing device, that is to say if the check carried out by the electronic computing device reveals that the motor vehicle is in manual driving mode, the control signal for displaying the virtual map for the driver of the motor vehicle is transmitted to the visual display device of the motor vehicle, for example, with the result that in particular the virtual map is displayed to the driver.

An aspect of the invention is based in particular on the following findings and considerations. By producing the virtual map with the recorded position of the motor vehicle and with the determined position of the further vehicle, road users can be positioned and tracked, in particular dynamically, on tickets, in particular segments of tickets, by displaying the virtual map. For example, not only can an event, for example in the form of a broken-down vehicle, and GPS data be passed on to the motor vehicle, but the road users can be positioned and tracked, in particular dynamically, on the tickets or the aforementioned map, and therefore a respective position of the road users can be reproduced, in particular with a certain level of confidence, for example in real time. Such information, that is to say in particular the data mentioned above, can come from a plurality of vehicles, for example in different driving directions and lanes. The data or the production of the virtual map make it possible to provide information, for example in the form of predictions, about any oncoming vehicles in an opposite lane or at an intersection for example, in particular in real time, to the motor vehicle and also by displaying the virtual map to the driver of the motor vehicle. By the displaying of the virtual map, the driver can adjust their driving behavior so that the driver does not overtake, for example, or adjust their driving strategy, for example, to drive slower or faster, for example, in order to avoid having to wait at an intersection. Furthermore, the driver can dispense with overtaking in the opposite lane, for example, in order not to have to brake too hard, for example. Furthermore, the driver and/or a high-beam assistant can switch a high beam of the motor vehicle particularly efficiently, for example, in particular on and off, with the result that the high beam can be switched on and off even earlier and more efficiently, for example. Therefore, safety of the motor vehicle can be further increased, for example, by the driver assistance system according to an aspect of the invention. Furthermore, the convenience of the motor vehicle, especially for the driver, can be particularly increased.

In a further configuration, it is provided that the electronic computing device is designed to check at least one hazard criterion for a, in particular current or imminent, driving situation of the motor vehicle, for example on the basis of the recorded position of the motor vehicle and/or on the basis of the determined position of the further vehicle. This means that the at least one hazard criterion can be checked or is checked by the electronic computing device for the, in particular current or imminent, driving situation, for example on the basis of the recorded position of the motor vehicle and/or on the basis of the recorded further position of the vehicle. In other words, the electronic computing device is used to check whether the hazard criterion is fulfilled or is not fulfilled, that is to say whether there is a hazard or there is no hazard for the driving situation. When the hazard criterion is fulfilled, the transmission of the control signal to the visual display device takes place by the electronic computing device, with the result that in particular the displaying of the virtual map takes place. In other words, the transmission of the control signal to the visual display device, and as a result in particular the displaying of the virtual map, is associated with the fulfilling of the hazard criterion. This means that the electronic computing device is designed to transmit the control signal for displaying the virtual map for the driver of the motor vehicle to the visual display device of the motor vehicle in manual driving mode, if the hazard criterion has been fulfilled or is fulfilled. That is to say, in particular, if it has been determined by the electronic computing device that there is a dangerous situation present. The hazard criterion is in particular a hazard criterion for a collision of the motor vehicle with the further vehicle. In other words, the hazard criterion characterizes in particular the collision of the motor vehicle with the further vehicle. For example, the hazard criterion has been fulfilled or is fulfilled if there is an intersection in the vicinity of the motor vehicle or a vehicle is traveling, in particular slowly, ahead of the motor vehicle and/or if the driver performs or wishes to perform an overtaking procedure. For example, the vehicle traveling slowly ahead is potentially dangerous because the driver is tempted to wish to overtake the slow vehicle, for example. By the displaying of the map, the driver can therefore adjust their driving behavior accordingly, that is to say, for example, not overtaking or looking ahead accordingly or approaching the intersection slowly.

In a further configuration, it is provided that the electronic computing device is designed to retrieve at least one item of information characterizing a driving behavior of the driver of the motor vehicle, stored in the electronic computing device for example, on which item of information the hazard criterion, that is to say in particular the fulfilling of the hazard criterion, is based. This means that the information characterizing the driving behavior of the driver of the motor vehicle can be retrieved or is retrieved by the electronic computing device. In other words, the checking of the hazard criterion takes place by the electronic computing device on the basis of the information characterizing the driving behavior of the driver of the motor vehicle. The driving behavior can be understood in particular to be past driving behavior of the driver, that is to say a driving behavior of the driver that has already happened. Habits, in particular driving habits, such as that the driver is a middle lane driver, usually drives at the target speed, drives at particularly high speeds, drives at particularly low speeds and/or tends to overtake, for example, can therefore be used to estimate, by the hazard criterion, whether the driver should be warned about or supported in the current driving situation by the virtual map, that is to say by the displaying of the virtual map. The driver's habits can thus be taken into account, in particular in an anonymized manner. This allows the fulfilling of the hazard criterion to be checked particularly precisely, which enables particularly good predictions to be made.

In a further configuration, it is provided that the, in particular received, data comprise at least one item of information characterizing a driving behavior of a driver of the further vehicle, on which item of information the hazard criterion, that is to say in particular the fulfilling of the hazard criterion, and/or the determination of the position of the further vehicle is based. In other words, the hazard criterion for the driving situation of the motor vehicle is checked by the electronic computing device, on the basis of the information characterizing the driving behavior of the driver of the further vehicle. Alternatively or additionally, the position of the further vehicle is determined by the electronic computing device on the basis of the information characterizing the driving behavior of the driver of the further vehicle. This allows the fulfilling of the hazard criterion to be checked particularly precisely. Furthermore, as a result of the fact that the determination of the position of the further vehicle is based on the information characterizing the driver of the further vehicle, this information can be used to determine the position of the further vehicle, with the result that the position of the further vehicle can be predicted particularly precisely, in particular when the data do not include current position data with regard to the further vehicle, for example.

In a further configuration, it is provided that the electronic computing device is designed to determine, in particular to calculate, on the basis of the data received by the receiving device, at least one probability that the further vehicle is situated at a defined or predetermined position which is different than the determined position of the further vehicle. This means that, by the electronic computing device on the basis of the data received by the receiving device, the probability can be determined or is determined, in particular can be calculated or is calculated, that the further vehicle is situated at the defined position. In particular, the probability can be understood to be a probability whether the further vehicle is not situated approximately at the determined, that is to say predicted, position in the surroundings, but at another position, different than the determined position, which is in particular the aforementioned defined position. This can be used to check how likely it is that the further vehicle is situated at a position in the form of the defined position that is particularly relevant for the driving situation of the motor vehicle, since position data of the further vehicle, contained in the data, may be out of date, for example, that is to say not up-to-date. It can thus be determined, for example using predictive route data or navigation data, for example taking into account destinations entered into a navigation system, the probability that the further vehicle is on a certain driving route on which the defined position in particular is situated. For example, this can enable the motor vehicle to enable an item of information in the form of a prediction regarding the representation of the surroundings, when oncoming traffic could arrive, for example.

In a further configuration, it is provided that the electronic computing device is designed to transmit at least one warning control signal for outputting a, for example haptic, acoustic and/or visual warning to an output device of the motor vehicle if the probability determined by the electronic computing device is higher than a, in particular predetermined or predefined, threshold value. This means that, by the electronic computing device, the warning control signal for outputting the warning to the output device of the motor vehicle can be transmitted or is transmitted, if the probability determined by the electronic computing device is higher than the threshold value, with the result that the warning can be output or is output to the driver in particular by the output device. In other words, the electronic computing device causes the output device to output the warning if the probability determined by the electronic computing device is higher than the threshold value. The driver can thus be particularly well warned about a potential danger. The output device is, for example, a different output device than the display device. Alternatively, the output device can be the display device.

In a further configuration, it is provided that the electronic computing device is designed to produce an object at the defined position in the virtual map if the probability determined by the electronic computing device is higher than the threshold value, with the result that, when the virtual map is displayed to the driver, in particular the object can be displayed or is displayed at the defined position in the virtual map. This means that, by the electronic computing device, the object can be produced or is produced at the defined position in the virtual map if the probability determined by the electronic computing device is higher than the threshold value. In other words, by the electronic computing device, the virtual map or the model is produced in such a way that the object is situated at the defined position in the virtual map or in the model. The object, for example in the form of an oncoming vehicle, can be used to warn the driver particularly well about a potential danger in the virtual map. The position of the object or the danger can be illustrated particularly well for the driver by the representation by the virtual map.

In a further configuration, it is provided that the driver assistance system has at least one surroundings recording device for recording the surroundings, in particular for recording the further vehicle in the surroundings. This means that, by the surroundings recording device, the surroundings of the motor vehicle, in particular the further vehicle situated in the surroundings, can be recorded or is recorded. Recording can be understood in particular to be detecting. The surroundings recording device is formed, for example, as a visual surroundings recording device, in particular as a camera. Alternatively or additionally, the surroundings recording device is formed, for example, as a Lidar sensor or as a radar sensor.

Preferably, it is provided that, when the further vehicle is recorded in the surroundings by the surroundings recording device, that is to say if the further vehicle in the surroundings is recorded or has been recorded by the surroundings recording device, the electronic computing device is designed to correct, that is to say in particular to adjust, the determined position on the basis of the further vehicle recorded by the surroundings recording device. This means that, when the further vehicle is recorded in the surroundings by the surroundings recording device, the determined position of the further vehicle can be corrected or is corrected, that is to say in particular can be adjusted or is adjusted, by the electronic computing device, on the basis of the further vehicle recorded by the surroundings recording device. The correction can be used to update the, in particular previously, determined position of the further vehicle. In this case, the determined position of the vehicle is determined again and therefore in particular updated, for example, by the electronic computing device on the basis of the further vehicle recorded by the surroundings recording device. As a result, the position of the further vehicle can be determined particularly precisely, with the result that particularly precise predictions, that is to say in particular particularly precise position representations of the further vehicle in the virtual map can be made possible.

Another aspect of the invention relates to a motor vehicle which has at least one driver assistance system. Advantages and advantageous configurations of one aspect of the invention are to be regarded as advantages and advantageous configurations of another aspect of the invention and vice versa.

Yet another aspect of the invention relates to a method for operating a motor vehicle. For example, the motor vehicle has a driver assistance system according to an aspect of the invention. The method can be understood in particular to be a method for operating a driver assistance system according to an aspect of the invention. In particular, the motor vehicle and/or the driver assistance system is designed to carry out the method. Advantages and advantageous configurations of one aspect of the invention are to be regarded as advantages and advantageous configurations of another aspect of the invention and vice versa.

In the method, a, in particular current, position of the motor vehicle is recorded by a position recording device of the motor vehicle, for example of the driver assistance system. Data characterizing at least one further vehicle are received by at least one receiving device of the motor vehicle, in particular of the driver assistance system, which data describe or characterize at least one position of the further vehicle. Furthermore, by an electronic computing device of the motor vehicle, in particular of the driver assistance system, the position of the further vehicle is determined on the basis of the data received by the receiving device. In addition, by the electronic computing device, at least one virtual map, in particular a road map, characterizing the surroundings of the motor vehicle, with the recorded position of the motor vehicle and with the determined position of the further vehicle, is produced, in particular automatically, on the basis of the recorded position of the motor vehicle and on the basis of the received data.

In order to be able to support the driver particularly well in their driving task, according to an aspect of the invention, in particular exclusively in a manual driving mode of the motor vehicle, at least one control signal for displaying the virtual map for the driver of the motor vehicle is transmitted by the electronic computing device to at least one visual display device of the motor vehicle, with the result that, in particular, the virtual map is displayed for the driver or to the driver by the visual display device. The display is therefore in particular a visual display.

For application cases or application situations which can arise in the method and which are not explicitly described here, provision can be made for an error message and/or a request for input of a user acknowledgement to be output according to the method and/or for a default setting and/or a predetermined initial state to be set.

An aspect of the invention also includes a control apparatus for the motor vehicle. The control apparatus is the electronic computing device, for example. The control apparatus can comprise a data processing apparatus or a processor unit (processor circuit) which is configured to perform one embodiment of the method according to an aspect the invention. The processor unit can have at least one microprocessor and/or at least one microcontroller and/or at least one FPGA (Field Programmable Gate Array) and/or at least one DSP (Digital Signal Processor) for this purpose. In particular, a CPU (Central Processing Unit), a GPU (Graphical Processing Unit), or an NPU (Neural Processing Unit) can each be used as a microprocessor. Furthermore, the processor device can have program code which is configured to perform the embodiment of the method according to an aspect the invention when executed by the processor unit. The program code can be stored in a data memory of the processor unit. The processor unit can be based, for example, on at least one circuit board and/or on at least one SoC (System on Chip)

The invention, according to an aspect, also includes developments of the method, which have features as have already been described in conjunction with the developments of the motor vehicle according to the invention and/or of the driver assistance system according to the invention. For this reason, the corresponding developments of the method according to the invention are not described here again.

As a further solution, an aspect of the invention also comprises a computer-readable storage medium comprising program code which, when executed by a computer or a computer network, causes it to carry out one embodiment of the method according to the invention. The storage medium can at least partially be provided as a non-volatile data memory (e.g. as a flash memory and/or as an SSD-solid state drive) and/or at least partially as a volatile data memory (e.g. as a RAM-random access memory). The storage medium can be arranged in the computer or computer network. The storage medium can, however, also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (e.g. C) and/or as a program script (e.g. Python). The computer-readable storage medium can alternatively be implemented by a signal having computer-readable data, for example a time-varying voltage signal and/or a radio signal.

The invention also comprises the combinations of the features of the embodiments described. The invention thus also comprises implementations which each have a combination of the features of a plurality of the embodiments described, unless the embodiments have been described as being mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described below, in which:

FIG. 1 shows a schematic plan view of a motor vehicle according to an aspect of the invention for illustrating a first traffic situation; and

FIG. 2 shows a schematic representation of a driver assistance system according to an aspect of the invention;

FIG. 3 shows a schematic representation of a virtual map depicting the first traffic situation according to an aspect of the invention;

FIG. 4 shows a schematic plan view of a motor vehicle according to an aspect of the invention for illustrating a second traffic situation;

FIG. 5 shows a schematic representation of a virtual map depicting the second traffic situation according to an aspect of the invention;

FIG. 6 shows a schematic plan view of a motor vehicle for illustrating a third traffic situation according to an aspect of the invention; and

FIG. 7 shows a schematic representation of a virtual map depicting the third traffic situation according to an aspect of the invention.

### DETAILED DESCRIPTION

Reference will now be made in detail to the preferred embodiments, examples of which are illustrated in the accompanying drawings, wherein like reference numerals refer to like elements throughout.

The exemplary embodiments explained below are preferred embodiments of the invention. In the exemplary embodiments, the described components of the embodiments are in each case individual features of the invention which are to be considered independently of one another and which in each case also develop the invention independently of one another. Therefore, the disclosure is intended to also comprise combinations of the features of the embodiments other than those depicted. Furthermore, the embodiments described can also be supplemented by further features of the invention which have already been described.

In the figures, identical reference signs denote functionally identical elements in each case.

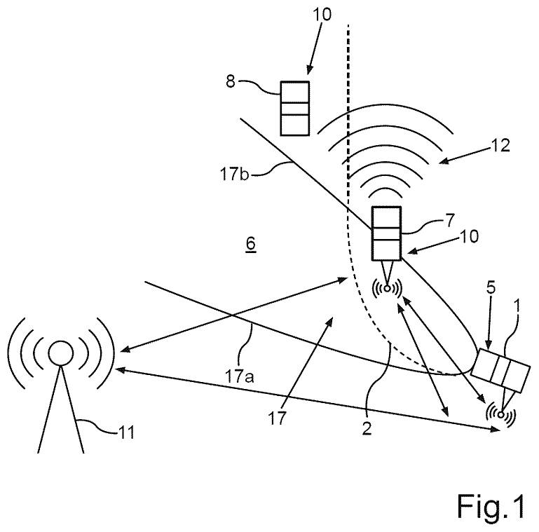

FIG. 1 shows, in a schematic plan view, a motor vehicle 1 which in the present case is situated on a roadway 2, that is to say is driving in particular on the roadway 2. The motor vehicle 1 can be referred to as an ego vehicle. The roadway 2, which is formed in particular by a road, is illustrated in FIG. 1 merely particularly schematically by dashed lines. In FIG. 1, a first traffic situation is illustrated in particular.

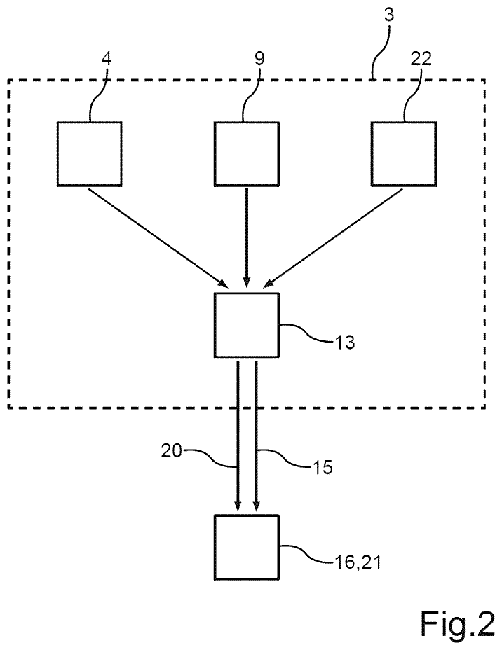

The motor vehicle 1 has a driver assistance system 3, which is illustrated in FIG. 2 in a particularly schematic depiction. The driver assistance system 3 has at least one position recording device 4 for recording a current position of the motor vehicle 1, in the surroundings 6 of the motor vehicle 1. The recording of the position by the position recording device 4 is based, for example, on GPS.

As illustrated in FIG. 1, in the present case at least one further vehicle is situated in the surroundings 6, wherein two further vehicles 7, 8 are situated in the surroundings 6 in the exemplary embodiment shown in FIG. 1. The further vehicle 7 can be referred to as the first further vehicle 7.

The further vehicle 8 can be referred to as the second further vehicle 8. The driver assistance system 3 has at least one receiving device 9, in particular different than the position recording device 4, for receiving data which characterize the first further vehicle 7 and/or the second further vehicle 8. Thus, the data characterize the respective further vehicle 7, 8, for example. If the following text refers to the “respective further vehicle 7, 8”, this may refer to the first further vehicle 7 and/or to the second further vehicle 8.

The data describe at least one, in particular current or past, position 10 of the respective further vehicle 7, 8, that is to say of the first and/or the second further vehicle 7, 8, for example. The data can be transmitted directly from the respective further vehicle 7, 8, that is to say from the respective first and/or from the respective second vehicle 7, 8 to the receiving device 9 of the motor vehicle 1, for example. Alternatively, the data of the respective further vehicle 7, 8, that is to say the data of the respective first and/or of the respective further vehicle 7, 8, for example, can be transmitted to a vehicle-external communication device 11, from which the data can be transmitted to the receiving device 9 of the motor vehicle 1, with the result that the receiving device 9 of the motor vehicle 1 can receive the transmitted data in particular. In the exemplary embodiment shown in FIG. 1, the second further vehicle 8 is recorded by at least one sensor device of the first further vehicle 7, with the result that the data characterizing the second further vehicle 8, for example, can be formed or produced by the first further vehicle 7. A recording area 12 of the sensor device of the first further vehicle 7 is illustrated in FIG. 1. These data can then be transmitted from the first further vehicle 7, for example directly or via the communication device 11, to the motor vehicle 1, in particular to the receiving device 9 thereof.

The motor vehicle 1, in particular the driver assistance system 3, further comprises at least one electronic computing device 13, which is designed to determine the position 10 or the respective position 10, that is to say in particular the position 10 of the first further vehicle 7 and/or the position 10 of the second further vehicle 8 on the basis of the data received by the receiving device 9. It can thus be determined where the first and/or second further vehicle 7, 8 is situated in the surroundings 6 relative to the motor vehicle 1.

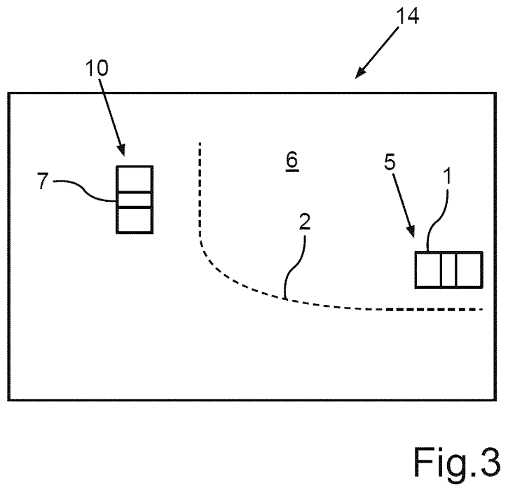

Furthermore, the electronic computing device 13 is designed to produce, on the basis of the recorded position 5 of the motor vehicle 1 and on the basis of the received data, that is to say in particular on the basis of the data characterizing the first and/or the second further vehicle 7, 8, a virtual map 14 which characterizes the surroundings 6, with the recorded position 5 of the motor vehicle 1 and with the determined position 10 or the respective determined position 10, that is to say in particular with the determined position 10 of the first and/or the second further vehicle 7, 8. The virtual map 14 therefore characterizes in particular the position 10 or the respective position 10. The virtual map 14 preferably characterizes the roadway 2, on which the motor vehicle 1 is driving in particular. The produced virtual map 14 depicts in particular the position 5 of the motor vehicle 1 and the position 10 or the respective position 10 of the respective further vehicle 7, 8 in the surroundings 6, and in particular the roadway 2. The virtual map 14 is depicted by way of example in FIG. 3 for the first traffic situation. In this case, in the exemplary embodiment shown in FIG. 3, only the second further vehicle 8 is shown in the virtual map 14 and not the first further vehicle 7. For example, in the virtual map 14, the position 5 of the motor vehicle 1 is represented by an, in particular motor-vehicle-like, object, which can be referred to as the first object. For example, the position 10 or the respective position of the respective further vehicle 7, 8 in the produced virtual map 14 is represented by at least one further object or at least one further respective object, which is in particular vehicle-like.

In order to support the driver of the motor vehicle 1 particularly well in their driving task, that is to say in a present traffic situation, for example, the electronic computing device 13 is designed to transmit, in a manual driving mode of the motor vehicle 1, that is to say in particular exclusively in manual driving mode, at least one control signal 15 for displaying the virtual map 14 for the driver of the motor vehicle 1 to at least one visual display device 16, in particular formed separately from the electronic computing device 13, of the motor vehicle 1, with the result that the virtual map 14 is displayed to the driver, in particular visually, for example two-dimensionally or three-dimensionally, in particular by the visual display device 16. This allows the driver to have a particularly good overview of the surroundings 6, that is to say of the present traffic situation in particular. The virtual map 14 is therefore in particular a representation based on the aforementioned data. In FIG. 1, a field of view 17 of the driver of the motor vehicle 1 is shown. The field of view 17 is delimited or illustrated in particular by two lines 17a, 17b. The field of view 17 is designed as a viewing cone, for example. Due to a curve in the roadway 2, the first and/or the second further vehicle 7, 8 are situated outside the field of view 17, for example, since the respective further vehicle 7, 8 is situated behind the curve, in particular from the point of view of the driver. By the displaying of the virtual map 14, in which in particular the position 10 of the first further vehicle 7 and/or the position 10 of the second further vehicle 8 is depicted or illustrated, in particular in the surroundings 6, preferably in relation to the motor vehicle 1, the driver can be forewarned that the first and/or the second further vehicle 7, 8 is situated behind the curve.

Thus, vehicles of a compatible fleet, for example, that is to say in the present case, for example, the motor vehicle 1, the first further vehicle 7 and/or second further vehicle 8 can record data regarding a present driving route and/or other road users. This is done outside of sensors, such as cameras, radar, Lidar and/or the like, for example. The data can be consolidated and/or shared with vehicles, such as the motor vehicle 1, which themselves cannot record corresponding information, for example, so that a corresponding visualization of the area surrounding the motor vehicle 1 can be made possible.

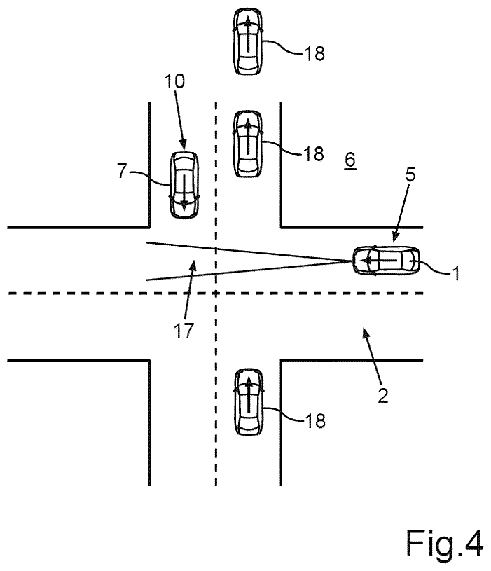

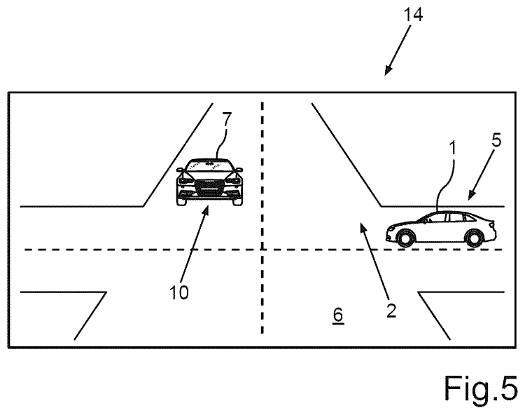

In FIG. 4, the motor vehicle 1 is also shown in a schematic plan view, wherein in FIG. 4 a second traffic situation, different than the first traffic situation, is illustrated. In this traffic situation, the motor vehicle 1 is approaching an intersection. In FIG. 4, by way of example the first further vehicle 7, which in the present case is situated outside the field of view 17 of the driver, is situated in the surroundings 6. The first further vehicle 7 is situated on a road that crosses the roadway 2 of the motor vehicle 1 at the intersection, for example. Furthermore, additional vehicles 18 are depicted by way of example in FIG. 4. In FIG. 5, the produced virtual map 14 for the second traffic situation, that is to say for the traffic situation shown in FIG. 4, is shown by way of example. As can be seen in FIG. 5, the position 10 of the first further vehicle 7 is illustrated or depicted in the virtual map 14, with the result that the driver can be warned about the first further vehicle 7, which in the present case is situated on the crossing road, by the virtual map 14 or by the displaying thereof.

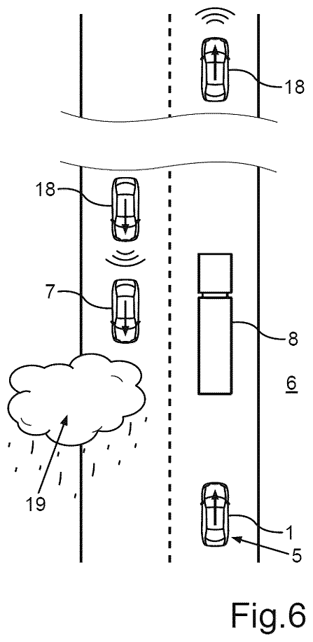

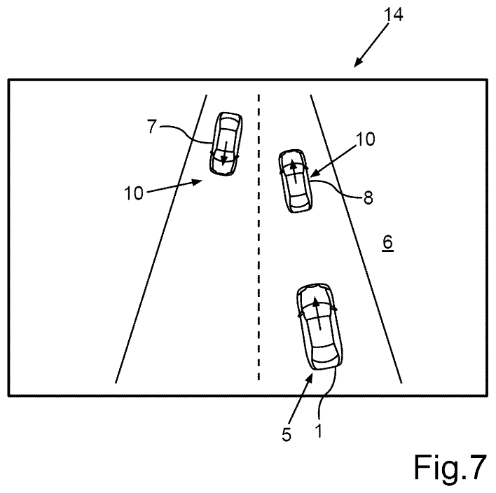

In FIG. 6, the motor vehicle 1 is also shown in a schematic plan view, wherein in FIG. 6 a third traffic situation, different than the first and the second traffic situation, is shown. In this traffic situation, the motor vehicle 1 is situated on a roadway 2, which in the present case is straight. The roadway 2 is thus formed as a straight route. Due, in particular, to bad weather conditions 19, such as fog, rain, snow or the like, for example, the view of the driver of the motor vehicle 1 is restricted or impeded, for example. In FIG. 6, the first further vehicle 7 and the second further vehicle 8 are depicted by way of example. The first further vehicle 7, in the present case, is situated on an opposite roadway with respect to the motor vehicle 1, with the result that in the present case the first further vehicle 7 is oncoming traffic for the driver of the motor vehicle 1. The second further vehicle 8 is formed as a truck in the exemplary embodiment shown in FIG. 6, which truck is traveling on the same roadway or lane as the motor vehicle 1. In FIG. 7, the produced virtual map 14 for the third traffic situation illustrated in FIG. 6 is shown. By the depiction of the first further vehicle 7 or the position 10 thereof in the produced virtual map 14, the driver can be warned about the oncoming first further vehicle 7, so that the driver does not overtake the second further vehicle 8, for example.

For example, the electronic computing device 13 is designed to check at least one hazard criterion, in particular automatically, for a traffic situation, in particular current or imminent, that is to say for example the first, second or third traffic situation, of the motor vehicle 1. This check is done in particular on the basis of the produced virtual map 14, that is to say for example on the basis of a model produced by the electronic computing device 13, on which model in particular the produced virtual map 14 is based. For example, the transmission of the control signal 15 to the display device 16 is done by the electronic computing device 13, in particular exclusively, when the hazard criterion is fulfilled, with the result that the displaying of the virtual map 14 is carried out in particular exclusively when the hazard criterion is fulfilled. Preferably, the transmission of the control signal 15 to the display device 16 is omitted when the hazard criterion is not fulfilled, with the result that in particular the displaying of the virtual map 14 by the display device 16 is omitted. The hazard criterion is fulfilled, for example, when at least one variable characterizing a hazard risk of a current traffic situation and/or driving situation is greater than a hazard threshold value. For example, the variable describes an accident probability. The hazard criterion is fulfilled, for example, when the motor vehicle 1 is in a potentially dangerous situation, for example before the curve, before the intersection and/or before an upcoming overtaking procedure and/or if bad weather conditions 19 are present.

As illustrated in FIG. 1 and in FIGS. 3 to 7, at least the following traffic situations, for example, can therefore be improved:
overtaking on a country road, in particular if the driver's visibility is not optimal, and/or
overtaking on a highway without missing an off-ramp, for example if many trucks are in front of the motor vehicle 1; and/or
driving the motor vehicle 1 toward the intersection, in particular if the driver's visibility is not good.

Furthermore, the virtual map 14 can be used to inform the driver, for example, of an exact position of a lane narrowing of the roadway 2, for example due to a construction site or due to an accident. Furthermore, by displaying the produced virtual map 14, the use of a high-beam function of the motor vehicle 1 can be particularly simplified, since the driver can leave the high beam activated until they recognize an oncoming vehicle on the virtual map 14, for example. High-beam illumination can take place in particular until no further vehicle has been recognized or scanned, for example.

For example, the electronic computing device 13 is designed to retrieve at least one item of information characterizing a driving behavior of the driver of the motor vehicle 1, on which item of information the hazard criterion is based. For this purpose, it is provided, for example, that the information characterizing the driving behavior is stored by the electronic computing device 13, for example in a memory of the electronic computing device 13. Subsequently, the stored information can be retrieved from the electronic computing device 13, that is to say loaded from the memory, for example. After the information has been retrieved, the information can be used for the hazard criterion, that is to say in particular for checking whether the hazard criterion is fulfilled. This allows the driver's habits to be taken into account when checking the hazard criterion.

Alternatively or in addition, it is provided, for example, that the received data include at least one item of information or respective information characterizing a driving behavior of a driver of at least one of the further vehicles 7, 8, on which information the hazard criterion and/or the determination of the position 10 or the respective position 10 of the respective further vehicle 7, 8 is based. It is therefore possible to take into account the habits of the drivers of the other vehicles 7, 8.

For example, it is therefore provided that if the information includes the fact that the driver of the motor vehicle 1 does not tend to perform overtaking procedures and in particular tends not to overtake trucks, the hazard criterion, for example, is not fulfilled in the presence of the upcoming overtaking procedure, in particular of the truck. The virtual map 14 therefore does not need to be displayed to the driver of the motor vehicle 1 as a warning of the upcoming overtaking procedure, for example, since they never overtake trucks, for example.

In a further configuration, it is provided that the electronic computing device 13 is designed to determine, on the basis of the data received by the receiving device 9, at least one probability that the further vehicle 7, 8 or the respective further vehicle 7, 8, that is to say the first further vehicle 7 and/or the second further vehicle 8, for example, is situated at a, in particular respective, defined position which in the present case is different than the determined position 10 or the respective determined position 10, that is to say for example the determined position 10 of the first further vehicle 7 and/or than the determined position 10 of the second further vehicle 8. This probability thus describes in particular how likely it is that the first and/or second further vehicle 7, 8 is situated not approximately at the determined respective position, but rather at the, in particular the respective, defined position. Furthermore, in the present case it is provided that the electronic computing device 13 is designed to produce an, in particular vehicle-like, object at the defined position in the virtual map 14, if the probability determined by the electronic computing device 13 is higher than a threshold value. The driver of the motor vehicle 1 can thus be signaled, by the virtual map 14, that a vehicle, that is to say the first further vehicle 7 and/or the second further vehicle 8, for example, may possibly be situated at the defined position, with the result that inaccuracies in the determination of the position 10 can be taken into account, for example. These inaccuracies can result, for example, from the fact that the data may already be out of date time of reception. The aforementioned object thus characterizes in particular an obstacle, for example a vehicle, which could possibly be at the defined position 5, indeed in particular with the aforementioned probability. This vehicle can therefore also be referred to as a phantom vehicle.

Alternatively or additionally, it is provided, for example, that the electronic computing device 13 is designed to transmit at least one warning control signal 20 for outputting a warning to an output device 21 of the motor vehicle 1, if the probability determined by the electronic computing device 13 is higher than the threshold value. In the exemplary embodiment, this output device 21 is the display device 16, which is formed in particular as a display. For example, the warning is depicted, in particular visually, in the virtual map 14.

For example, the motor vehicle 1, in particular the driver assistance system 3, has at least one surroundings recording device 22 for recording the surroundings 6, in particular for recording at least one of the further vehicles 7, 8 situated in the surroundings 6. In this case, when the at least one of the further vehicles 7, 8 is recorded in the surroundings 6 by the surroundings recording device 22, the electronic computing device 13 is designed, for example, to correct, that is to say in particular to adjust, the determined position 10 or the respective determined position 10, that is to say for example the determined position 10 of the first further vehicle 7 and/or the determined position 10 of the second further vehicle 8, on the basis of the surroundings recorded by the surroundings recording device 22, that is to say in particular on the basis of the first further vehicle 7 recorded by the surroundings recording device 22 and/or of the second further vehicle 8 recorded by the surroundings recording device 22. Thus, an adjustment of the phantom vehicle can be made if the latter has been recorded by the surroundings recording device 22. Alternatively or in addition, the correction can be used to validate the determined position 10 or the respective determined position 10.

The surroundings recording device 22 comprises, for example, at least one camera, at least one ultrasonic sensor, at least one Lidar sensor and/or at least one radar sensor. The recording of the surroundings 6 can thus be based, for example, on camera recording, ultrasonic recording, radar recording and/or Lidar recording.

For example, driving events, in particular of the respective traffic situation, can be recorded by sensors. These sensors can be sensors of the motor vehicle 1 and/or sensors of the first further vehicle 7 and/or the second further vehicle 8. For example, using the electronic computing device 13, the data are standardized and/or categorized, in particular initially, for example on the basis of a respective recorded vehicle type of the respective further vehicle 7, 8. This can be used, for example, to determine whether the respective further vehicle 7, 8 is a passenger car or a truck, for example. Furthermore, data can include further information, such as a, in particular current, speed of the respective further vehicle 7, 8, for example, that is to say of the respective first further vehicle 7 and/or of the respective second further vehicle 8, for example, and/or a used lane. This further information can also be incorporated into the production of the virtual map 14, that is to say in particular into the aforementioned model. Vehicles on the same driving route, in particular in the same direction of travel and/or on an opposite roadway, and/or vehicles that are traveling ahead with respect to the motor vehicle 1, can consolidate the information and/or data and in particular pass it on to the motor vehicle 1.

Overall, it can be seen that a method for the determination and visualization of road users, that is to say in particular for anticipating road users, can be created by the driver assistance system 3. Here, for example, a predicted position of vehicles based on predicted speed can be displayed to the driver by the produced virtual map 14. In particular, the driver can be informed that they can expect oncoming traffic in the amount of the aforementioned probability, for example, in particular from the overtaking procedure. This allows the driver to adjust their driving behavior in manual driving mode, in particular through reproduction of the virtual map, that is to say as a result of information contained in the map, and to not carry out the overtaking procedure, for example. A hazard probability, for example of an approaching intersection and/or overtaking maneuver, can be determined by the electronic computing device 13 using sensor data and/or map data. From this, the virtual map 14 can be produced, in particular with the position of all the vehicles and phantom vehicles. The virtual map 14 can be maintained in the back end. Furthermore, the motor vehicle 1 or the driver thereof can be informed about a potential danger on the basis of the virtual map 14, as soon as the probability of danger is significant, so that the driver can adjust their driving behavior.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A driver assistance system for a motor vehicle, comprising:
a position recording device to record a position of the motor vehicle;
a receiving device to receive data characterizing at least one further vehicle, the data describing at least one position of the at least one further vehicle;
an electronic computing device which is designed to:
determine the at least one position of the at least one further vehicle based on the data received by the receiving device, and
produce a virtual map, characterizing a surrounding of the motor vehicle, with the recorded position of the motor vehicle and with the determined at least one position of the at least one further vehicle, based on the recorded position of the motor vehicle and the received data,
wherein the electronic computing device is designed to transmit, in a manual driving mode of the motor vehicle, a control signal to display the virtual map for a driver of the motor vehicle to a visual display device of the motor vehicle.

2. The driver assistance system as claimed in claim 1, wherein
the electronic computing device is designed to check a hazard criterion for a driving situation of the motor vehicle, and
the transmission of the control signal to the visual display device takes place by the electronic computing device based on the hazard criterion being fulfilled.

3. The driver assistance system as claimed in claim 2, wherein
the electronic computing device is designed to retrieve at least one item of information characterizing a driving behavior of the driver of the motor vehicle, on which item of information the hazard criterion is based.

4. The driver assistance system as claimed in claim 2, wherein
the data comprises at least one item of information characterizing a driving behavior of a driver of the at least one further vehicle, on which item of information the hazard criterion and/or the determination of the at least one position of the at least one further vehicle is based.

5. The driver assistance system as claimed in claim 3, wherein
the data comprises at least one item of information characterizing a driving behavior of a driver of the at least one further vehicle, on which item of information the hazard criterion and/or the determination of the at least one position of the at least one further vehicle is based.

6. The driver assistance system as claimed in claim 1, wherein
the electronic computing device is designed to determine, based on the data received by the receiving device, a probability that the at least one further vehicle is situated at a defined position which is different than the determined at least one position of the at least one further vehicle.

7. The driver assistance system as claimed in claim 6, wherein
the electronic computing device is designed to transmit a warning control signal to output a warning to an output device of the motor vehicle based on the probability determined by the electronic computing device being higher than a threshold value.

8. The driver assistance system as claimed in claim 6, wherein
the electronic computing device is designed to produce an object at the defined position in the virtual map based on the probability determined by the electronic computing device being higher than a threshold value.

9. The driver assistance system as claimed in claim 7, wherein
the electronic computing device is designed to produce an object at the defined position in the virtual map based on the probability determined by the electronic computing device being higher than a threshold value.

10. The driver assistance system as claimed in claim 1, which comprises
a surrounding recording device to record the surrounding,
wherein, based on the at least one further vehicle being recorded as being in the surrounding by the surrounding recording device, the electronic computing device is designed to correct the determined at least one position based on the at least one further vehicle being recorded by the surrounding recording device.

11. A motor vehicle with the driver assistance system as claimed in claim 1.

12. A method for operating a motor vehicle, comprising:
recording, in which a position of the motor vehicle is recorded by a position recording device, data characterizing at least one further vehicle which is received by a receiving device, the data describing at least one position of the at least one further vehicle;
determining, by an electronic computing device, the at least one position of the at least one further vehicle based on the data received by the receiving device, and
producing, by the electronic computing device, a virtual map characterizing a surrounding of the motor vehicle, with the recorded position of the motor vehicle and with the determined at least one position of the at least one further vehicle based on the recorded at least one position of the motor vehicle and the received data,
wherein, in a manual driving mode of the motor vehicle, a control signal to display the virtual map for a driver of the motor vehicle is transmitted by the electronic computing device to a visual display device of the motor vehicle.
